(19) United States
(12) Patent Application Publication
(10) Pub. No.: US 2010/0208543 A1
(43) Pub. Date: Aug. 19, 2010

(54) FLUID MIXING DEVICE AND FLUID MIXING METHOD

(76) Inventors: Katsuyoshi Takahashi, Osaka-shi (JP); Takehiko Kitamori, Bunkyo-ku (JP)

Correspondence Address: NIXON & VANDERHYE, PC, 901 NORTH GLEBE ROAD, 11TH FLOOR, ARLINGTON, VA, 22203, US

(21) Appl. No.: 12/707,932

(22) Filed: Feb. 18, 2010

(30) Foreign Application Priority Data
Feb. 19, 2009 (JP) 2009-036815

(51) Int. Cl. B01F 15/04; B01F 13/02

(52) U.S. Cl. 366/101; 366/167.1; 366/160.5

(57) ABSTRACT

A micromixer 100 includes a mixing chamber 1 in which a liquid plug A6 is introduced, and a fluid channel section 2 in which a liquid plug B7 is flowed. The fluid channel section 2 is connected to the mixing chamber 1. The micromixer 100 causes the liquid plug B7 that flows inside the fluid channel section 2 to accelerate in a direction towards the mixing chamber 1 and to flow into the mixing chamber 1, so that the liquid plug B7 comes in contact with the liquid plug A6. This allows efficient stirring and mixing of the liquid plug A6 and liquid plug B7.

This Nonprovisional application claims priority under 35 U.S.C. §119(a) on Patent Application No. 2009-036815 filed in Japan on Feb. 19, 2009, the entire contents of which are hereby incorporated by reference.

### TECHNICAL FIELD

The present invention relates to a fluid mixing device and a fluid mixing method. More specifically, the present invention relates to a fluid mixing device and a fluid mixing method, each of which mixes a fluid in a minute reaction space of the order of nanometer to micrometer.

### BACKGROUND ART

Recently, attention has been given to a technique in which a minute channel of the order of nanometer to micrometer is formed on a chip made of glass or resin, so as to carry out analysis in the formed channel in chemical and biological fields. Such a technique is called pTAS (micro total analysis system), or Lab-on-a-chip. With this technique, in order to carry out various analyses on the fine chip, development has been progressing for elemental technologies such as fluid carriage, mixing, and detection on the fine chip.

In a case where analysis and reaction operation is to be carried out by use of a liquid on such a fine chip, efficient stirring of liquid and mixing of a plurality of liquids becomes important, in order to accomplish a highly accurate and quick analysis. Generally, in a microspace such as a minute reaction channel of the order of nanometer to micrometer, the liquid becomes a laminar flow that is influenced by liquid viscosity, and stirring and mixing of the liquid by molecular diffusion becomes possible.

As a technique that uses the molecular diffusion, Patent Literature 1 discloses a reaction mechanism including a chip provided with a confluence channel which causes merging of liquids that flow in respective plurality of channels. In this reaction mechanism, the confluence channel has a mixing area and a reaction area that are provided in a consecutive manner. After the liquid that is merged together is mixed in the mixing area, reaction of the liquid proceeds in the reaction area.

Moreover, Patent Literature 2 discloses a mixing mechanism in which a plurality of liquid channels are merged at respective confluence points, and further branching channels are provided at the confluence points to branch out a portion of the merged liquid. This causes the liquids to consecutively confluence, branch out, and again confluence. In this mixing mechanism, mixing is carried out by molecular diffusion while the liquid is consecutively merged and branched, thereby attaining a liquid mixture with a large mixing ratio. Furthermore, Patent Literature 3 discloses a technique in which droplets are mixed by (i) traveling the droplets automatically by electrowetting so that the droplets come in contact with each other, then (ii) mixing the droplets by use of a circulation generated due to molecular diffusion and movement of the droplets that come in contact with each other.

### Citation List

### Patent Literature

Patent Literature 1

Japanese Patent Application Publication, Tokukai, No. 2005-30999 A (Publication Date: Feb. 3, 2005)

Patent Literature 2

Japanese Patent Application Publication, Tokukai, No. 2005-10031 A (Publication Date: Jan. 13, 2005)

Patent Literature 3

Japanese Patent Application Publication, Tokukai, No. 2006-317363 A (Publication Date: Nov. 24, 2006)

### SUMMARY OF THE INVENTION

### Technical Problem

However, if the liquids are mixed by (i) bringing the liquids in contact to each other and (ii) causing molecular diffusion to the liquids, a long time is required to sufficiently mix the liquids. Particularly in a case where a reaction channel is used, the reaction channel needs to be long to sufficiently mix the liquids.

The present invention is accomplished in view of the foregoing problem, and its object is to provide a fluid mixing device and a fluid mixing method, each of which efficiently stirs and mixes fluid particularly in a minute reaction space (microspace) of the order of nanometer to micrometer.

### Solution to Problem

In order to attain the object, a fluid mixing device in accordance with the present invention includes: a mixing chamber in which a first liquid is introduced; and a fluid channel section connected to the mixing chamber, in which fluid is introduced, the fluid flowed in the fluid channel section being accelerated in a direction towards the mixing chamber, so that the fluid flows into the mixing chamber and comes in contact with the first liquid.

The fluid mixing device in accordance with the present invention stirs and mixes fluid and a first liquid. Namely, if the fluid is a gas, the fluid mixing device stirs the first liquid with the gas, and if the fluid is a second liquid, the fluid mixing device mixes the first liquid and the second liquid together. According to the configuration, the fluid being accelerated in the fluid channel section is brought into contact with the first liquid in the mixing chamber. Thus, the fluid collides with the first liquid in strong momentum. If the fluid is a second liquid, the second liquid collides and is mixed with the first liquid. Impact of the collision causes generation of an eddy inside the mixed liquid of the first liquid and second liquid, thereby accelerating the mixing of the first liquid and second liquid. Moreover, if the fluid is a gas, the gas collides with the first liquid. Impact of the collision causes generation of an eddy inside the first liquid, thereby accelerating the stirring of the first liquid. As a result, the mixing of the first and second liquids or the stirring of the first liquid is carried out efficiently.

The fluid mixing device in accordance with the present invention preferably includes a gas exhausting channel section in which gas is flowed, provided on a surface parallel to an inflowing direction of the fluid and connected to the mixing chamber.

The foregoing configuration allows efficient removal of gas existing in the mixing chamber and the fluid channel section between the first liquid and the fluid, by flowing the gas into the gas exhausting channel section, before the first liquid comes in contact with the fluid. This results in efficiently stirring and mixing the first liquid. Moreover, the gas that flows into the gas exhausting channel section flows along the liquid in the mixing chamber. Due to this flow of gas, a circulation generates inside the liquid in the mixing chamber. This circulation allows even more efficient stirring and mixing of the liquid.

The fluid mixing device in accordance with the present invention further preferably includes: a first pressure section for applying pressure to the mixing chamber from a gas exhausting channel section side on an interface of the mixing chamber and the gas exhausting channel section, to form a pressure barrier that prevents a liquid component in the mixing chamber from flowing into the gas exhausting channel section.

This configuration prevents liquid from flowing into the gas exhausting channel section from the mixing chamber. As a result, the liquid is retained in the mixing chamber and fluid channel section, thereby allowing efficient stirring and mixing of the first liquid.

The fluid mixing device in accordance with the present invention is preferably configured in such a manner that a first distance of the gas exhausting channel section is of a same length or shorter than a second distance of the mixing chamber, the first distance and second distance being in a direction (i) perpendicular to an inflowing direction of the fluid and (ii) parallel to an interface of the mixing chamber and the gas exhausting channel section.

According to the configuration, the gas exhausting channel section has a depth shallower than that of the mixing chamber. This allows efficient removal of gas existing between the first liquid and the fluid by flowing the gas into the gas exhausting channel section from the mixing chamber and the fluid channel section, before the first liquid and the fluid come in contact with each other. Further, this retains the liquid in the mixing chamber and fluid channel section, thereby allowing efficient stirring and mixing of the first liquid.

The fluid mixing device in accordance with the present invention is preferably configured in such a manner the second distance has a ratio with respect to the first distance of not less than 1 but not more than 10. This allows efficient use of stirring and mixing liquid by molecular diffusion, to further quickly stir and mix the first liquid.

The fluid mixing device in accordance with the present invention is preferably configured in such a manner that at least one of the mixing chamber, the fluid channel section, and the gas exhausting channel section has a hydrophobic inner section. This prevents the liquid in the mixing chamber and fluid channel section from flowing into the gas exhausting channel section, by use of a hydrophobic pressure barrier (Laplace pressure). As a result, stirring and mixing of the first liquid is carried out more efficiently. Moreover, this configuration efficiently removes the gas that exists between the first liquid and the fluid by causing the gas to flow into the gas exhausting channel section, before the first liquid and the fluid come in contact with each other. Particularly, by providing a hydrophobic inner section of the fluid channel section, an interaction between the fluid channel section and the fluid is reduced while the fluid flows inside the fluid channel section. Thus, it is possible to reduce an amount of energy required to accelerate the fluid. As a result, the first liquid can be mixed more efficiently.

In the fluid mixing device in accordance with the present invention, at least one of the mixing chamber, the fluid channel section, and the gas exhausting channel section has an angle of contact with respect to water in its inner section of not less than 90 degrees but not more than 180 degrees. This allows attaining the effect of the Laplace pressure in a direction in which the liquid is retained in the mixing chamber 1. Moreover, by especially configuring the inner side of the fluid channel section 2 as the foregoing, the energy required to accelerate the fluid can be further reduced.

In the fluid mixing device in accordance with the present invention, it is preferable that the mixing chamber has a capacity greater than (a) a volume of the first liquid in a case where the fluid is a gas or (b) a total of volumes of the first liquid and the second liquid in a case where the fluid is a second liquid. This allows containing in the mixing chamber 1 a full amount of the liquid to be stirred and mixed, and makes it possible to form a gas-liquid interface on an interface of the liquid and the gas exhausting channel section. As a result, the first liquid is stirred and mixed more efficiently.

In the fluid mixing device in accordance with the present invention, (a) the volume of the first liquid in the case where the fluid is a gas and (b) the total of volumes of the first liquid and the second liquid in the case where the fluid is a second liquid are preferably not less than 1 pL but not more than 1 μL. This makes it possible to increase a surface area ratio (specific interfacial area) of the liquid with respect to the volume of the liquid. Hence, it is possible to stir and mix the first liquid more efficiently.

The fluid mixing device in accordance with the present invention is preferably configured in such a manner that the fluid is a second liquid, the fluid mixing device further including: at least one volume setting section connected to the fluid channel section, for introducing the first liquid or second liquid that is set in volume, into the fluid channel section. By this configuration, it is possible to set the volumes of the first and second liquids that are involved in the stirring or mixing, by use of just one device. This makes it possible to measure the liquid and stir and mix the fluid in one series of easily carried out operations.

The fluid mixing device in accordance with the present invention is configured in such a manner that the volume setting section preferably includes: a cutting-off channel section for flowing the first liquid or second liquid therein; a volume setting channel section connected to the cutting-off channel section so as to intersect at right angles with a flowing direction of the first liquid or second liquid flowing in the cutting-off channel section, the volume setting channel section having an identical capacity to the first liquid or second liquid of the set volume; a valve channel section connected between the volume setting channel section and the fluid channel section; and a second pressure section for (i) applying a first pressure to an interface of the volume setting channel section and the valve channel section from the valve channel section side so that the volume setting channel section is filled with the first liquid or second liquid flowing in the cutting-off channel section, the first pressure preventing the first liquid or second liquid from flowing into the valve channel section from the volume setting channel section, and thereafter (ii) applying a second pressure higher than the first pressure to the first liquid or second liquid in the volume setting channel section from the cutting-off channel section side. This allows accurate setting of volume of the first liquid or second liquid that is involved in the stirring or mixing.

The fluid mixing device in accordance with the present invention preferably includes a plurality of volume setting sections which respectively have volume setting channel sections of different capacities. This configuration makes it possible to easily carry out setting and mixing of liquids having different volume ratios, in one device.

The fluid mixing device in accordance with the present invention preferably further includes: a pressure applying section for applying a third pressure to a fluid introduced into the fluid channel section, to accelerate the fluid in the direction towards the mixing chamber. This makes it possible to efficiently accelerate the fluid, and efficiently stir and mix the first liquid by the generation of an eddy caused by the contact of the fluid with the first liquid.

In the fluid mixing device in accordance with the present invention, the third pressure is preferably not less than 1 kPa but not more than 1 MPa. This makes it possible to accelerate the fluid more efficiently.

A fluid mixing method in accordance with the present invention includes: (A) causing a first liquid introduced in a mixing chamber to come into contact with a fluid accelerated in a direction towards the mixing chamber.

The fluid mixing method in accordance with the present invention stirs and mixes the fluid and the first liquid. Namely, if the fluid is a gas, the method causes stirring of the first liquid with the gas, and if the fluid is a second liquid, the method causes the first liquid and the second liquid to be mixed together. According to the configuration, the fluid being accelerated in the fluid channel section is brought into contact with the first liquid in the mixing chamber. Thus, the fluid collides with the first liquid in strong momentum. If the fluid is a second liquid, the second liquid collides and is mixed with the first liquid. Impact of the collision causes generation of an eddy inside the mixed liquid of the first liquid and second liquid, thereby accelerating the mixing of the first liquid and second liquid. Moreover, if the fluid is a gas, the gas collides with the first liquid. Impact of the collision causes generation of an eddy inside the first liquid, thereby accelerating the stirring of the first liquid. As a result, the mixing of the first and second liquids or the stirring of the first liquid is carried out efficiently.

The fluid mixing method in accordance with the present invention preferably further includes: accelerating the fluid before the step (A), by applying a fourth pressure to the fluid in the direction towards the mixing chamber, in the step (A), the fluid thus accelerated being caused to come in contact with the first liquid. This efficiently accelerates the fluid, and efficiently stirs and mixes the first liquid by an eddy generated due to the fluid and first liquid coming in contact with each other.

In the fluid mixing method in accordance with the present invention, the fourth pressure is not less than 1 kPa but not more than 1 MPa. This accelerates the fluid more efficiently.

It is preferable in the fluid mixing method in accordance with the present invention that the mixing chamber is tubular shaped, and in the step (A), the fluid is caused to come in contact with the first liquid from a shorter side of the mixing chamber. This makes it possible to increase a surface area ratio of the liquid (specific interfacial area) with respect to the volume of the liquid, thereby allowing more efficient stirring and mixing of the first liquid.

The fluid mixing method in accordance with the present invention is preferably configured in such a manner that the fluid is a second liquid, the fluid mixing method further including: accelerating the second liquid before the step (A), by causing a first gas to come in contact with the second liquid in the direction toward the mixing chamber, in the step (A), the second liquid thus accelerated being caused to come in contact with the first liquid. This efficiently accelerates the second liquid, and efficiently mixes the first liquid and second liquid due to an eddy generated by the first liquid and the second liquid that come in contact with each other.

It is preferable that in the fluid mixing method in accordance with the present invention, pressure is applied to the first gas in a range of not less than 1 kPa to not more than 1 MPa. Hence, it is possible to accelerate the fluid more efficiently.

It is preferable that in the fluid mixing method in accordance with the present invention, the fluid is a second liquid, and the step (A) includes: causing, after the first liquid comes in contact with the second liquid, a second gas to come in contact with a mixed liquid of the first liquid and second liquid so as to flow the second gas along an interface of the mixed liquid. This causes generation of a circulation in the mixed liquid in the mixing chamber, due to the gas that flows along an interface of the mixed liquid. As a result, the first liquid and the second liquid are mixed more efficiently.

The fluid mixing method in accordance with the present invention is preferably configured in such a manner that, in the step (A), the second gas is caused to be in contact with the mixed liquid so that the mixed liquid moves inside the mixing chamber. This further causes generation of circulation in the mixed liquid due to movement of the mixed liquid, thereby resulting in more efficient mixing of the first and second liquids.

It is preferable that in the fluid mixing method in accordance with the present invention, the fluid is a second liquid, and the first liquid has a volume different from that of the second liquid. Since the volume ratios of the first liquid and the second liquid are different from each other, it is possible to mix the first liquid and second liquid more efficiently by use of this volume difference between the first liquid and second liquid, at a time when the second liquid comes into contact with the first liquid.

It is preferable that in the fluid mixing method in accordance with the present invention, a total of volumes of the first liquid and the second liquid is not less than 1 pL but not more than 1 μL. This makes it possible to increase the surface area ratio (specific interfacial area) of liquid with respect to the volume of the liquid. Thus, it is possible to mix the first liquid more efficiently.

It is preferable that in the fluid mixing method in accordance with the present invention, the fluid is a third gas, and the step (A) includes: causing the third gas to come in contact with the first liquid so as to flow the third gas along an inter face of the first liquid. This efficiently accelerates the third gas, and efficiently stirs the first liquid by causing generation of an eddy due to the third gas coming in contact with the first liquid.

In the fluid mixing method in accordance with the present invention, the first liquid preferably has a volume of not less than 1 pL but not more than 1 μL. This increases the surface area ratio (specific interfacial area) of the first liquid with respect to the volume of the first liquid, thereby resulting in stirring the first liquid more efficiently.

### Advantageous Effects of Invention

As described above, according to the fluid mixing device and fluid mixing method in accordance with the present invention, a first liquid introduced in the mixing chamber is caused to come in contact with a fluid which is accelerated in the fluid channel section. Thus, it is possible to efficiently stir and mix the first liquid and the fluid.

### BRIEF DESCRIPTION OF DRAWINGS

FIG. 1

FIG. 1 is a top view schematically illustrating one embodiment of a micromixer in accordance with the present invention.

FIG. 2

FIG. 2 is a top view schematically illustrating one embodiment of a micromixer in accordance with the present invention.

FIG. 3

FIG. 3 is a top view schematically illustrating one embodiment of a micromixer in accordance with the present invention.

FIG. 4

FIG. 4 is a top view schematically illustrating one embodiment of a micromixer in accordance with the present invention.

FIG. 5

FIG. 5 is a top view schematically illustrating one embodiment of a micromixer in accordance with the present invention.

FIG. 6

FIG. 6 is a top view schematically illustrating one embodiment of a micromixer in accordance with the present invention.

FIG. 7

FIG. 7 is a top view schematically illustrating one embodiment of a micromixer in accordance with the present invention.

FIG. 8

FIG. 8 is a diagram schematically illustrating a volume setting section of a micromixer in accordance with the present invention.

FIG. 9A

FIG. 9A is a diagram schematically illustrating how a volume is set by a volume setting section of a micromixer in accordance with the present invention.

FIG. 9B

FIG. 9B is a diagram schematically illustrating how a volume is set by a volume setting section of a micromixer in accordance with the present invention.

FIG. 9C

FIG. 9C is a diagram schematically illustrating how a volume is set by a volume setting section of a micromixer in accordance with the present invention.

FIG. 10

FIG. 10 is a diagram schematically illustrating how a liquid is stirred by use of a micromixer in accordance with the present invention.

FIG. 11A

FIG. 11A is a diagram schematically illustrating how a liquid is mixed by use of a micromixer in accordance with the present invention.

FIG. 11B

FIG. 11B is a diagram schematically illustrating how a liquid is mixed by use of a micromixer in accordance with the present invention.

FIG. 11C

FIG. 11C is a diagram schematically illustrating how a liquid is mixed by use of a micromixer in accordance with the present invention.

FIG. 11D

FIG. 11D is a diagram schematically illustrating how a liquid is mixed by use of a micromixer in accordance with the present invention.

FIG. 12A

FIG. 12A is a diagram schematically illustrating how a liquid is mixed by use of a micromixer in accordance with the present invention.

FIG. 12B

FIG. 12B is a diagram schematically illustrating how a liquid is mixed by use of a micromixer in accordance with the present invention.

FIG. 12C

FIG. 12C is a diagram schematically illustrating how a liquid is mixed by use of a micromixer in accordance with the present invention.

FIG. 12D

FIG. 12D is a diagram schematically illustrating how a liquid is mixed by use of a micromixer in accordance with the present invention.

FIG. 12E

FIG. 12E is a diagram schematically illustrating how a liquid is mixed by use of a micromixer in accordance with the present invention.

FIG. 13

FIG. 13 is an image illustrating a result of mixing liquid by use of a micromixer in accordance with the present invention.

FIG. 14A

FIG. 14A is an image illustrating a result of mixing liquid by use of a micromixer in accordance with the present invention.

FIG. 14B

FIG. 14B is an image illustrating a result of mixing liquid by use of a micromixer in accordance with the present invention.

FIG. 14C

FIG. 14C is an image illustrating a result of mixing liquid by use of a micromixer in accordance with the present invention.

FIG. 14D

FIG. 14D is an image illustrating a result of mixing liquid by use of a micromixer in accordance with the present invention.

FIG. 15

FIG. 15 is a graph illustrating a result of mixing a liquid by use of a micromixer in accordance with the present invention.

### DESCRIPTION OF EMBODIMENTS

One embodiment of the present invention is described below with reference to FIGS. 1 through 5. FIGS. 1 through 5 are top views schematically illustrating one embodiment of a micromixer in accordance with the present invention. As shown in FIG. 1, a micromixer (fluid mixing device) 100 in accordance with the present invention includes a mixing chamber 1 and a fluid channel section 2. The mixing chamber 1 has a liquid plug A (first liquid) 6 introduced therein. One end of the fluid channel section 2 is connected to one end of the mixing chamber 1, and fluid flows inside the fluid channel section 2. The present embodiment first explains a case where the fluid flowing in the fluid channel section 2 is a liquid (liquid plug B (second liquid) 7), and then explains a case where the fluid is a gas.

The mixing chamber 1 may have any width (distance in vertical direction in FIG. 1) as long as the width is in a range of 1 μm to 1000 μm. The mixing chamber 1 may have any depth (distance in a direction perpendicular to an inflowing direction of the liquid plug B7 and parallel to an interface of the mixing chamber 1 and the gas exhausting channel section 3) as long as the depth is in a range of 1 μm to 1000 μm, however is preferably in a range of 1 μm to 200 μm. A length of the mixing chamber 1 (distance in horizontal direction in FIG. 1) is adjusted as appropriate with respect to a volume of the liquid plug A6 and liquid plug B7, and is preferably in a range of 0.1 mm to 100 mm. Note that it is preferable to set a size of the mixing chamber 1 so that a capacity of the mixing chamber 1 is greater than a total volume of the liquid plug A6 and liquid plug B7 to be mixed together (preferably in a range of 1 pL to 1 μL).

The fluid channel section 2 may have any width (distance in vertical direction in FIG. 1) as long as the width is in a range of 1 μm to 1000 μm, and any depth (direction perpendicular to the inflowing direction of liquid plug B7 and parallel to an interface of the mixing chamber 1 and gas exhausting channel section 3) as long as the depth is in a range of 1 μm to 1000 μm. Moreover, it is preferable that the fluid channel section 2 has a length (distance in horizontal direction in FIG. 1) in a range of 0.1 mm to 500 mm. A size of a cross section of the mixing chamber 1 and the fluid channel section 2 where the two are connected to each other may be the same or different. The micromixer 100 in accordance with the present invention is not limited in size such as the width, depth, and length to the foregoing range, and may be for example of the order of nm.

Parts in the mixing chamber 1 and fluid channel section 2 other than the parts where the liquid plug A6 and liquid plug B7 are present are desirably filled with a substance that does not interfere with the liquid plug A6 and liquid plug B7, and various gases (preferably air) is sufficiently filled therein. Alternatively, if necessary, the substance thus filled may be oil or the like.

The micromixer 100 is formed by, for example, processing glass or resin substrates by methods such as wet or dry etching or mechanical processing. Moreover, the micromixer 100 may be constructed in such a manner that after the processing, another substrate (not illustrated) that has a fluid inlet and an outlet is provided as a, lid.

As shown in FIG. 1, the liquid plug B7 in the fluid channel section 2 flows in a direction of the arrow. The liquid plug B7 flows into the mixing chamber 1 from one end of the fluid channel section 2 that is connected to one end of the mixing chamber 1, and comes in contact with the liquid plug A 6. At this time, the liquid plug B7 is accelerated in the fluid channel section 2 in the direction towards the mixing chamber 1, and is flowed into the mixing chamber 1 in an accelerated manner. This causes the liquid plug B7 to collide with the liquid plug A6 in strong momentum. Circulation generated due to this impact efficiently mixes together the liquid plug A 6 and liquid plug B7. Particularly, compared to mixing just by the diffusion of liquid, it is possible to mix the liquid plug A6 and liquid plug B7 in a short time.

The micromixer 100 can include an accelerating section (not illustrated) that accelerate the liquid plug B7 in the fluid channel section 2 in a direction towards the mixing chamber 1. Although it is possible to use a pressure device that applies pressure in the fluid channel section 2, a decompression device that reduces pressure in the fluid channel section 2, or an electrically driven device (dielectrophoresis, electrowetting) as the foregoing accelerating section, it is preferable to use the pressure device that applies pressure to the fluid channel section 2. As the pressure device as such, a device which applies pressure (third pressure) to the liquid plug B7 introduced inside the fluid channel section 2 to accelerate the liquid plug B7 in the mixing chamber 1 direction may be used. Moreover, the pressure device is preferably a device which introduces pressurized gas into the fluid channel section 2, such as a pressure controller. The pressure applied to the pressurized gas is preferably, but not limited to, not less than 1 kPa to not more than 1 MPa.

As shown in FIG. 1, the micromixer 100 may include a gas exhausting channel section 3 connected to the mixing chamber 1, which gas exhausting channel section 3 is provided on a surface which is (i) parallel to the inflowing direction of the liquid plug B7 in the mixing chamber 1 and fluid channel section 2 and (ii) perpendicular to a surface at which the mixing chamber and fluid channel section are connected (top surface in FIG. 1). In the present embodiment, a micromixer including the gas exhausting channel section 3 is used as an example in the description. The gas exhausting channel section 3 may be connected to both the mixing chamber 1 and fluid channel section 2.

The gas exhausting channel section 3 may have any width (distance in vertical direction in FIG. 1) as long as the width is in a range of 1 μm to 1000 μm. The gas exhausting channel section 3 may have any depth (direction perpendicular to inflowing direction of liquid plug B7 and parallel to an interface of the mixing chamber 1 and gas exhausting channel section 3) as long as the depth is in a range of 1 μm to 1000 μm. However, the depth is preferably in a range of 1 μm to 200 μm. The gas exhausting channel section 3 preferably has a length (distance in a horizontal direction in FIG. 1) in a range of 0.1 mm to 500 mm. An end of the gas exhausting channel section 3 that is not connected to the mixing chamber 1 is an opening 5 that leads to a gas outlet (not illustrated).

The depth of the gas exhausting channel section 3 (first distance) is preferably shallower than the depth of the mixing chamber 1 (second distance), and a ratio of the depth of the mixing chamber 1 with respect to the depth of the gas exhausting channel section 3 is preferably not less than 1 but not more than 10. By having the depth of the mixing chamber in a range of 1 μm to 1000 μm, preferably in a range of 1 μm to 200 μm, and having a ratio of the depth of the mixing chamber 1 with respect to the depth of the gas exhausting channel section 3 as not less than 1 but not more than 10, it is possible to shorten a time required for diffusion even if diffusion is necessary to mix in a depth direction of the mixing chamber 1. Moreover, by having the depth ratio of the gas exhausting channel section 3 to the mixing chamber 1 as not less than 1 but not more than 10, it is possible to sufficiently retain the liquid plug A6 in the mixing chamber 1.

As shown in FIG. 1, a pressure barrier 4 is formed at an interface of the mixing chamber 1 and the gas exhausting channel section 3, by applying pressure to the mixing chamber from the gas exhausting channel section 3 side. The pressure barrier 4 prevents liquid components in the mixing chamber 1 from flowing into the gas exhausting channel section 3. Hence, the micromixer 100 may include a first pressing section (not illustrated) for forming the foregoing pressure barrier 4. Conventionally known means are usable as the first pressing section. The pressure barrier 4 in the present embodiment is not a real wall that is provided between the mixing chamber 1 and gas exhausting channel section 3, but is a hypothetical wall that prevents movement of liquid component at an interface of the mixing chamber 1 and the gas exhausting channel section 3.

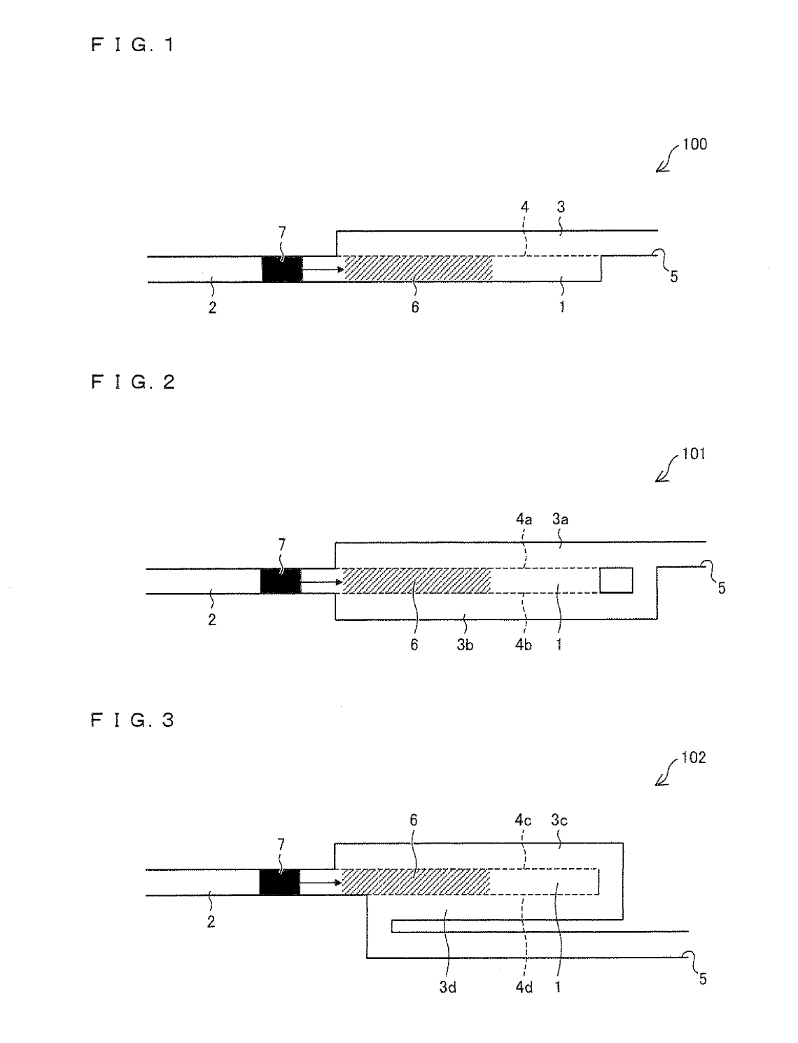

The gas exhausting channel section 3 is not limited in its shape as illustrated in FIG. 1, and may have gas exhausting channel sections 3a and 3b on both surfaces of the mixing chamber 1 that are (i) parallel to the inflowing direction of the liquid plug B7 of the mixing chamber 1 and (ii) perpendicular to a surface where the mixing chamber 1 and fluid channel section 2 are connected together, as in the micromixer 101 illustrated in FIG. 2 for example. As illustrated in FIG. 2, a pressure barrier 4a is formed at an interface of (i) the gas exhausting channel section 3a and (ii) the mixing chamber 1 and fluid channel section 2, and a pressure barrier 4b is formed at an interface of the gas exhausting channel section 3b and the mixing chamber 1. Ends of the gas exhausting channel sections 3a and 3b that are not connected to the mixing chamber 1 are merged together as one opening 5. Alternatively, the ends of the gas exhausting channel sections 3a and 3b that are not connected to the mixing chamber 1 can be provided without being connected to each other, and each end serving as separate openings 5.

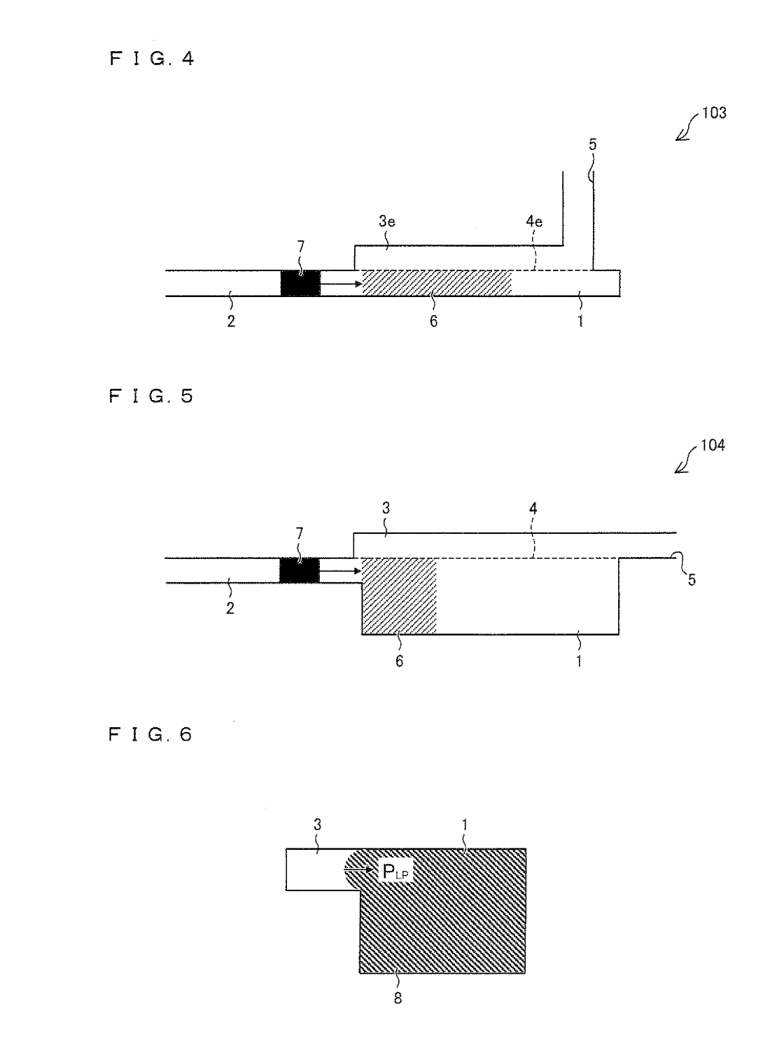

Moreover, as in a micromixer 102 illustrated in FIG. 3, a gas exhausting channel section 3c and a gas exhausting channel section 3d may be provided in a consecutive manner. In this case, one end of the gas exhausting channel section 3d serves as the opening 5. A pressure barrier 4c is formed at an interface of the gas exhausting channel section 3c and the mixing chamber 1, and a pressure barrier 4d is formed at an interface of the gas exhausting channel section 3d and the mixing chamber 1. Furthermore, as in a micromixer 103 illustrated in FIG. 4, a gas exhausting channel section 3e may be provided on a portion of a surface that is (i) parallel, to an inflowing direction of the liquid plug B7 in the mixing chamber 1 and (ii) perpendicular to a surface where the mixing chamber 1 and fluid channel section 2 are connected, and the remaining portion of the surface may be not provided with the gas exhausting channel section 3e. Similarly to FIGS. 1 to 3, a pressure barrier 4e is formed on an interface of the gas exhausting channel section 3e and the mixing chamber 1, as illustrated in FIG. 4.

In the above configurations, the mixing chamber 1 is not limited in shape to the illustrated shapes, and may be, for example, in a shape corresponding to FIG. 1 but having the gas exhausting channel section 3 partially connected to the surface that is (i) parallel to the inflowing direction of the liquid plug B7 in the mixing chamber 1 and (ii) perpendicular to a surface where the mixing chamber 1 and fluid channel section 2 are connected together, as illustrated in FIG. 4. Moreover, the mixing chamber 1, fluid channel section 2 and gas exhausting channel section 3 may be of a cylindrical shape. Furthermore, as in a micromixer 104 illustrated in FIG. 5, the mixing chamber 1 may have a width remarkably wider than that of the fluid channel section 2 and gas exhausting channel section 3. Moreover, widths and depths of the mixing chamber 1, fluid channel section 2, and gas exhausting channel section 3 do not require to be the same, and may also be of a tapered form with which the width and depth gradually broaden or become narrow, or just a portion of the width and depth may be shaped wide or narrow.

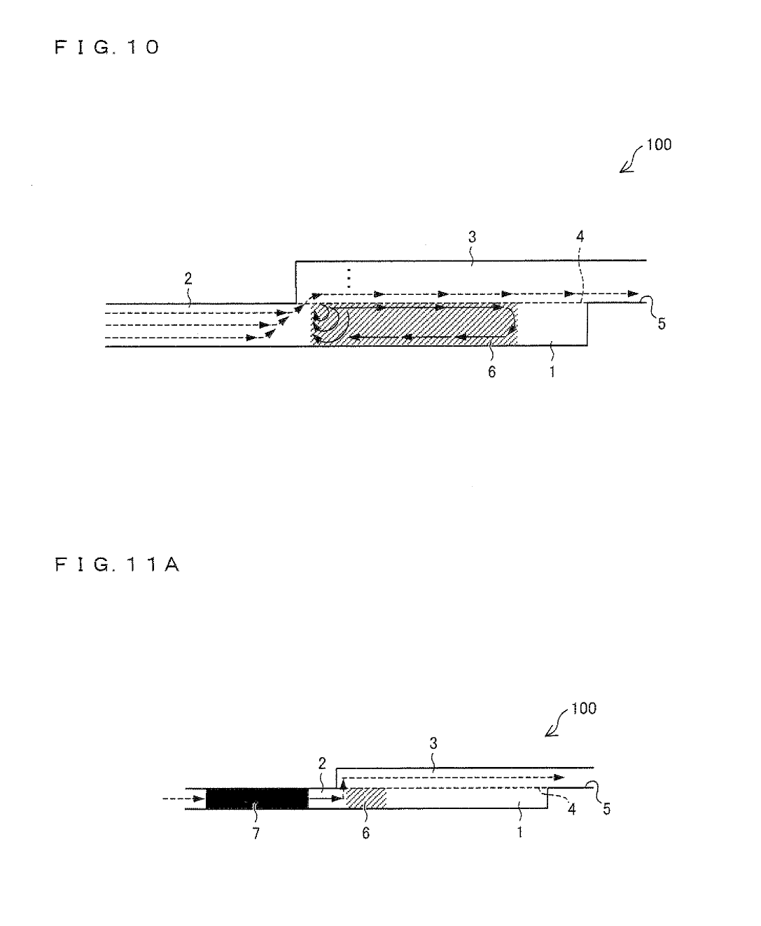

As such, by providing the gas exhausting channel section 3, it is possible to guide the gas existing between the liquid plug A6 and liquid plug B7 to the gas exhausting channel section 3, before the liquid plug B7 that flows into the mixing chamber 1 comes in contact with the liquid plug A6. This makes it possible to mix the liquid plug A6 and liquid plug B7 by causing the two liquid plugs to come in contact with each other. Moreover, after the liquid plug A6 and liquid plug B7 come in contact with each other in the mixing chamber 1, gas is flowed from the fluid channel section 2 in the direction towards the mixing chamber 1, to cause generation of an eddy and circulation in a mixed liquid 12 of the liquid plug A6 and liquid plug B7 (FIG. 10B). Thus, particularly in a case where the liquid plug A6 and liquid plug B7 have a large volume ratio, it is possible to mix the two liquids more quickly. The eddy and circulation that generates in the mixed liquid 12 is later described in detail.

In order to provide a gas-liquid interface between a liquid component 8 (FIG. 6) and the gas exhausting channel section 3, and prevent the liquid component 8 from leaking into the gas exhausting channel section 3, it is necessary to provide a pressure barrier 4 between the mixing chamber 1 and the gas exhausting channel section 3 in a direction that retains the liquid component 8 inside the mixing chamber 1. The liquid component 8 here denotes the liquid plug A6 or the mixed liquid 12 including the liquid plug A6 and liquid plug B 7. The pressure barrier 4, represented as P_{LP}, is calculated by the following Young-Laplace formula (1):

P_{LP}=−2γ·cos θ/(dh/2) (1),

where γ is surface tension acting on the liquid component 8 of the mixing chamber 1; θ is an angle of contact of the liquid component 8; and dh is an equivalent diameter of the gas-liquid interface inside the liquid component 8 and gas exhausting channel section 3.

Therefore, in a case where the surface tension acting on the liquid component 8 in the mixing chamber 1 is stable, a stronger hydrophobicity of the gas exhausting channel section 3 (θ>90 degrees) and a smaller equivalent diameter (the shallower the depth) allows the liquid component 8 to be stably held in the mixing chamber 1. Note that this applies in a case where a water-based liquid component 8 is used, and when an oil-based liquid component 8 is used, the hydrophilic and hydrophobic relation applies in the opposite way round. This case also is included in the present invention.

An inner side of the gas exhausting channel section 3 is preferably hydrophobic. Moreover, an angle of contact with respect to water on a hydrophobic surface is preferably in a range of not less than 90 degrees but not more than 180 degrees. Therefore, the inner side of the gas exhausting channel section 3 may be either made of hydrophobic material, or may be modified to be hydrophobic. Resin such as Teflon (Registered Trademark) or PDMS may be used as the hydrophobic material. As a hydrophobic modifying agent to modify the inner side of the gas exhausting channel section 3 to be hydrophobic, amorphous fluoropolymer, octadecyltrichlorosilane or the like may be suitably used. Similarly, an inner side of the mixing chamber 1 is also preferably hydrophobic.

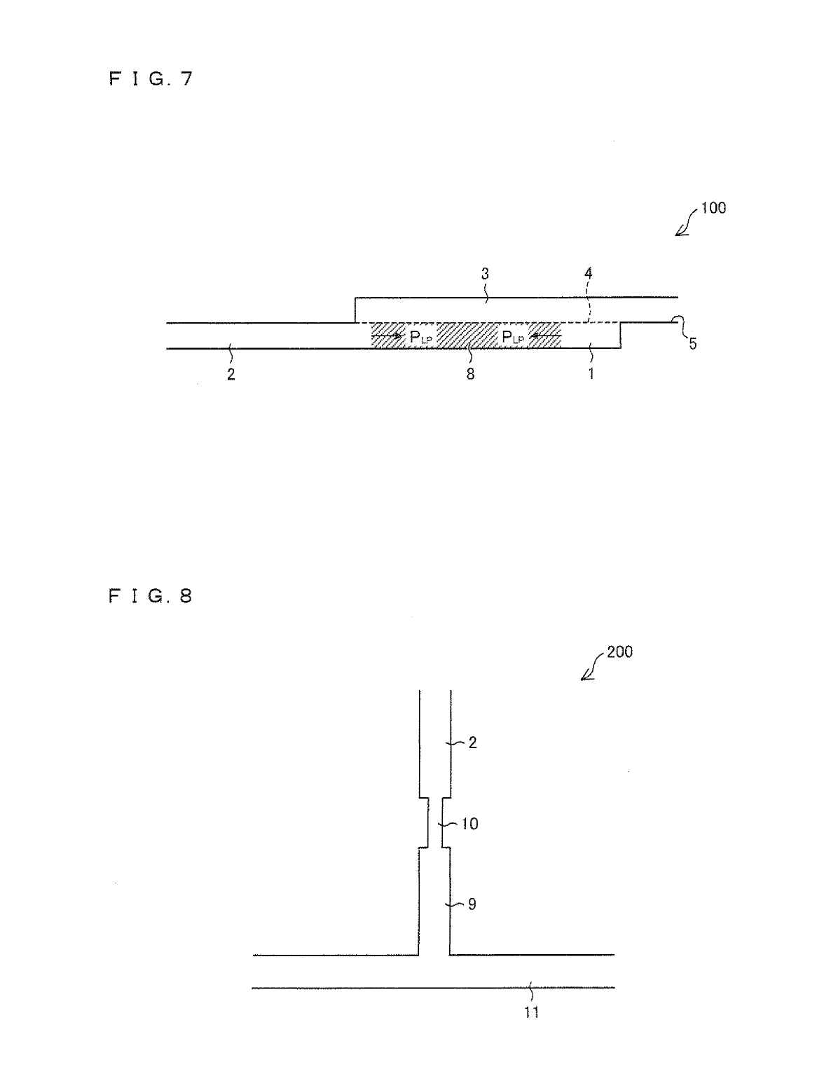

The following description deals with a relationship of the mixing chamber 1, gas exhausting channel section 3, and liquid component 8 in a case where the pressure barrier 4 is formed, with reference to FIGS. 6 and 7. FIG. 6 is a cross sectional view schematically illustrating a relationship of the mixing chamber 1, gas exhausting channel section 3, and liquid component 8, in a case where the pressure barrier 4 is formed by applying pressure to an interface of the mixing chamber 1 and the gas exhausting channel section 3. FIG. 7 is a top view schematically illustrating a relationship between the mixing chamber 1, gas exhausting channel section 3, and liquid component 8, in a case where the pressure barrier 4 exists.

As illustrated in FIG. 6, in order to retain the liquid component 8 in the mixing chamber 1, a pressure P_{LP} is applied to the mixing chamber 1 from the gas exhausting channel section 3 side. By applying the P_{LP}, it is possible to push back the liquid component 8 that flows from the mixing chamber 1 towards the gas exhausting channel section 3 side back into the mixing chamber 1. Moreover, as illustrated in FIG. 7, the pressure barrier 4 is formed by applying the P_{LP}, and further the P_{LP} may be applied to both ends of the liquid component 8. This thus adjusts position and length of the liquid component 8 inside the mixing chamber 1, and fixes the liquid component 8 inside the mixing chamber 1.

Moreover, similarly to the mixing chamber 1 and the gas exhausting channel section 3, an inner side of the fluid channel section 2 is also preferably modified to be hydrophobic, or modified to be water-repellent or oil-repellent. Such a configuration reduces interaction of the liquid plug B7 with an inner wall of the fluid channel section 2, when the liquid plug B7 is flowed into the fluid channel section 2. As a result, the liquid plug B7 is efficiently accelerated with just a small amount of force, thereby allowing efficient mixing of the liquid plug A6 and the liquid plug B7. It is preferable that an angle of contact with respect to water inside the fluid channel section 2 is not less than 90 degrees but not more than 180 degrees. As the hydrophobic modifying agent or the water-repellent or oil-repellent modifying agent, amorphous fluoropolymer, octadecyltrichlorosilane or the like is suitably used. Moreover, instead of carrying out such a hydrophobic or water-repellent/oil-repellent modification, the fluid channel section 2 may be made of resin material such as Teflon (Registered Trademark) or PDMS, each of which originally shows hydrophobic or water-repellent/oil-repellent properties. Furthermore, to enhance the hydrophobic or water-repellent/oil-repellent effect, the fluid channel section 2 may have projections and depressions provided on its inner wall.

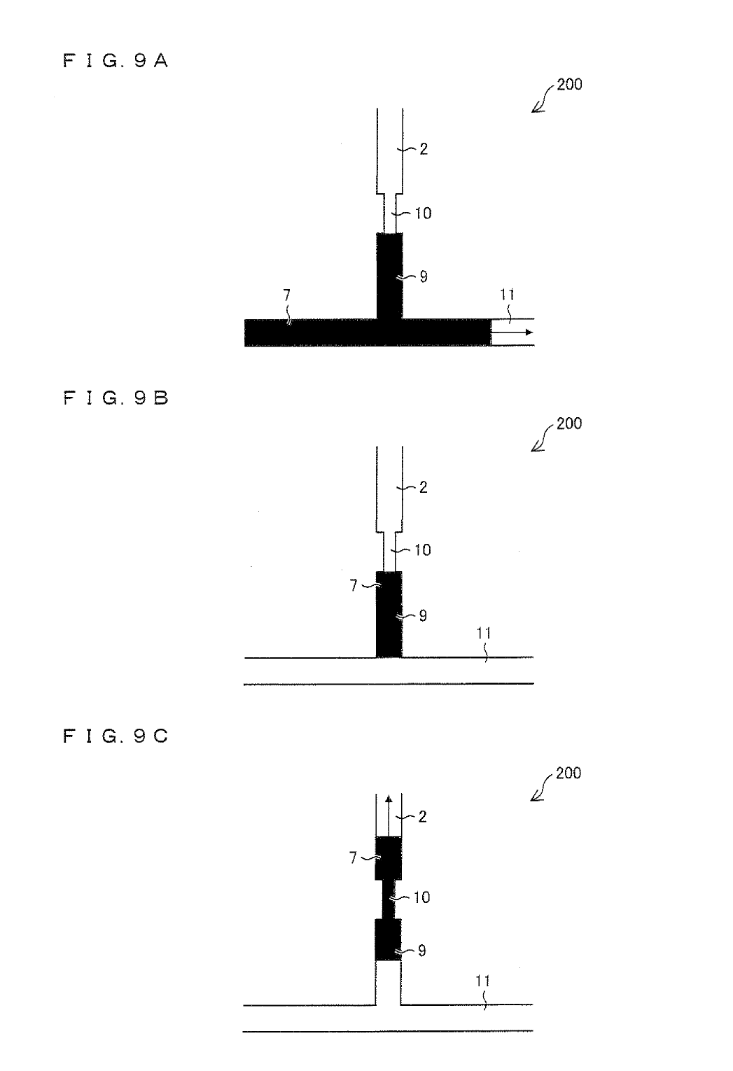

The micromixer 100 in accordance with the present invention may include a volume setting section 200 which introduces the liquid plug A6 or liquid plug B7 of a set volume to the fluid channel section 2. The following description deals with the form of the micromixer 100 which includes the volume setting section 200, with reference to FIGS. 8, 9A, 9B, and 9C. The present embodiment explains a method to set a volume of the liquid plug B7 by using the volume setting section 200. FIG. 8 is a top view schematically illustrating one embodiment of the volume setting section 200. FIGS. 9A to 9C are explanatory diagrams describing a method for setting the volume by use of the volume setting section 200 illustrated in FIG. 8.

As illustrated in FIG. 8, the volume setting section 200 includes a volume setting channel section 9, a valve channel section 10, and a cutting-off channel section 11. In the cutting-off channel section 11, the liquid plug B7 that has not been set in volume flows. The volume setting channel section 9 is connected to the cutting-off channel section 11 so as to intersect at right angles with a flowing direction of the liquid plug B7 that flows inside the cutting-off channel section 11. The volume setting channel section 9 has a capacity identical to the liquid plug B7 to be introduced in the fluid channel section 2 after the volume is set. The valve channel section 10 is either directly or indirectly connected between the volume setting channel section 9 and the fluid channel section 2.

The volume setting channel section 9 has a capacity designed to have a same volume as a desired volume, so that the liquid plug B7 of the desired volume is introducible into the fluid channel section 2. It is preferable that the volume setting channel section 9 has a width (distance in horizontal direction in FIG. 8) and a depth (distance in a perpendicular direction to the width and a length described below) in a range of 1 μm to 1000 μm, and a length (distance in vertical direction in FIG. 8) in a range of 1 μm to 50 mm. However, the ranges are not limited to the foregoing ranges.

Pressure is applied to an interface of the volume setting channel section 9 and the valve channel section 10 from the valve channel section 10 side by a second pressure section (not illustrated), to prevent the inflow of the liquid plug B7 from the volume setting channel section 9 to the valve channel section 10. This forms a pressure barrier on the interface of the volume setting channel section 9 and the valve channel section 10, in a direction that retains the liquid plug B7 in the volume setting channel section 9.

A relationship of the pressure barrier and direction of the pressure is represented as similar to the relationship of the foregoing formula (1). The valve channel section 10 preferably has an equivalent diameter in a range of 1 μm to 1000 μm and a length (vertical direction in FIG. 8) in a range of 1 μm to 1000 μm. However, the present invention is not limited to the foregoing ranges. Moreover, the valve channel section 10 is preferably made of hydrophobic material or is modified to be hydrophobic, for the same reasons as the foregoing gas exhausting channel section 3. The cutting-off channel section 11 preferably has a width (distance in vertical direction of FIG. 8) and depth (distance in a direction perpendicular to the width and a length described below) in a range of 1 μm to 1000 μm, and preferably has a length (horizontal direction in FIG. 8) in a range of 1 μm to 100 mm. However, the present invention is not limited to these ranges.

The following description explains a method for setting a volume by use of the volume setting section 200, with reference to FIGS. 9A to 9C. As illustrated in FIG. 9A, the liquid plug B7 that flows in the cutting-off channel section 11 flows into the volume setting channel section 9 from a part at which the cutting-off channel section 11 and the volume setting channel section 9 are connected. The liquid plug B7 flowed into the volume setting channel section 9 is retained in the volume setting channel section 9 without flowing back into the valve channel section 10, due to the pressure barrier formed at the interface of the volume setting channel section 9 and the valve channel section 10. It is desirable to apply a pressure lower than the pressure of the pressure barrier, at a time when the liquid plug B7 flows into the volume setting channel section 9 from the cutting-off channel section 11.

After the liquid plug B7 flows into the volume setting channel section 9 as illustrated in FIG. 9B, a substance that does not interfere with the liquid plug B7 (mainly gas such as air) is introduced in the cutting-off channel section 11, at a pressure lower than the pressure of the pressure barrier. This sets the volume of the liquid plug B7 having a substantially same volume as the capacity of the volume setting channel section 9. Thereafter, as illustrated in FIG. 9C, a pressure higher than that of the pressure barrier is applied to the liquid plug B7 in the volume setting channel section 9 from the cutting-off channel section 11 side, so that the liquid plug B7 set in volume is flowed into the fluid channel section 2 via the valve channel section 10.

As described above, by using the volume setting section 200, it is possible to measure with the device an extremely minute amount of liquid to be mixed, by the micromixer 100. That is to say, it is possible to complete a series of operations from measurement to mixing and stirring of the liquid in one device. This allows more efficient mixing and stirring of the liquid. With a conventional mixing device, it is difficult to set a volume of a minute amount of liquid such as 1 nL then introduce this amount to a mixing device for mixing the liquid. However, since the micromixer 100 in accordance with the present invention includes the volume setting section 200, it is possible to set the minute amount of liquid and stir and mix the liquid in one device, in one series of operations. As a result, stirring and mixing of liquid of a minute amount can be carried out with good accuracy.

The volume setting section 200, as described above, may include a pressure section (second pressure section) for (i) applying a pressure (first pressure) to an interface of the volume setting channel section 9 and the valve channel section 10 from the valve channel section 10 side, which pressure prevents the liquid plug B7 from flowing into the valve channel section 10 from the volume setting channel section 9, so that the volume setting channel section 9 is filled with the liquid plug B7 flowing in the cutting-off channel section 11, and then (ii) applying a pressure (second pressure) higher than the foregoing pressure to the liquid plug B7 in the volume setting channel section 9 from the cutting-off channel section 11 side.

Moreover, the micromixer 100 may include a plurality of volume setting sections 200. In such a case, one volume setting section 200 may be used to set the volume of the liquid plug A6, and another volume setting section 200 may be used to set the volume of the liquid plug B7; thereafter, the liquid plug A6 set in volume is introduced into the mixing chamber 1 via the fluid channel section 2, and subsequently the liquid plug B7 is introduced into the fluid channel section 2. As described above, by setting volumes of the liquid plug A6 and liquid plug B7 with use of different volume setting sections 200, it is possible to mix the liquid plug A6 and liquid plug B 7 that are set with different volume ratios. Here, the liquid plug A6 and liquid plug B7 that are set in volume with a plurality of volume setting sections 200 may have respective volume ratios as 2 or more. Moreover, a volume of the liquid set by the volume setting section 200 may be in a range of 1 pL to 1 μL.

The following description deals with the micromixer 100 in a case where the fluid that flows in the fluid channel section 2 is gas, with reference to FIG. 10. FIG. 10 is a diagram schematically illustrating stirring of a liquid by the micromixer 100. Even if the fluid that flows in the fluid channel section 2 is gas, the configuration of the micromixer 100 is identical to the case where the fluid flowing in the fluid channel section 2 is the liquid plug B7. As illustrated in FIG. 10, the gas flowing in the fluid channel section 2 in the direction of the arrow flows into the mixing chamber 1, comes into contact with the liquid plug A6, and thereafter flows into the gas exhausting channel section 3 and is lead out from the opening 5.

At this time, the gas is accelerated in the fluid channel section 2 in the direction towards the mixing chamber 1 and is flowed into the mixing chamber 1. As a result, the gas collides with the liquid plug A6 in strong momentum, and the gas that flowed inside the gas exhausting channel section 3 flows along the interface of the liquid plug A6, thereby causing generation of eddy and circulation inside the liquid plug A6 as illustrated in FIG. 10. As illustrated in FIG. 10, an eddy generates in an induced manner by the flow of the gas from an impact surface of the gas in the impacted liquid plug A6. At an interface of the gas flowing in the gas exhausting channel section 3 and the liquid plug A6, a shear flow induced by the flow of gas generates in the liquid plug A6, in a right direction as shown in FIG. 10. The liquid plug A6 as a whole is retained in the mixing chamber 1. Therefore, in order to balance with the flow in the right direction in FIG. 10, a flow in the left direction in FIG. 10 generates in the liquid plug A6. By the eddy and circulation generated as such, it is possible to efficiently and quickly stir the liquid plug A6. In this case, the mixing chamber 1 functions as a stirring chamber.

As such, the micromixer 100 in accordance with the present invention can efficiently stir the liquid plug A6. This makes it possible to stir and mix in the liquid plug A6, not just components that are soluble, but also particulate components. Therefore, the micromixer 100 in accordance with the present invention is suitably used for efficiently stirring a liquid plug A6 that includes components of uneven concentrations, which stirring is required in many analyses.

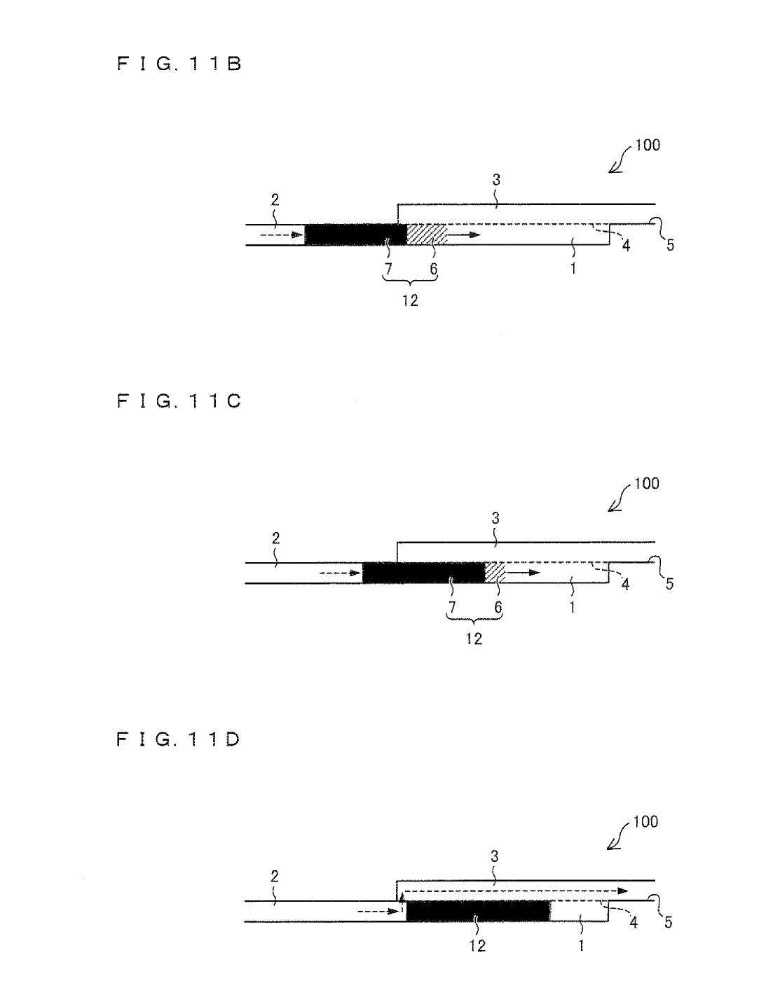

The following description specifically explains the mixing of the liquid plug A6 and liquid plug B7, with reference to FIGS. 11A, 11B, 11C, and 11D. FIGS. 11A to 11D are diagrams schematically illustrating how the liquids are mixed together by the micromixer 100. As illustrated in FIG. 11A, the liquid plug B7 flows in the fluid channel section 2 in a direction towards the mixing chamber 1. Pressurized gas (first gas) is made to come in contact with the liquid plug B7 that flows in the fluid channel section 2. It is preferable that pressure is applied to the gas to not less than 1 kPa but not more than 1 MPa.

The liquid plug A6 stands still in the mixing chamber 1, and the liquid plug A6 can have a volume of not less than 1 pL but not more than 1 μL. Gas is included between the liquid plug A6 and liquid plug B7 in the fluid channel section 2, however the gas is exhausted to the gas exhausting channel section 3 as the liquid plug B7 comes closer to the liquid plug A6, as illustrated by the arrow in the dotted lines.

Thereafter, as illustrated in FIG. 11B, once the liquid plug B7 comes in contact with the liquid plug A6, the liquid plug B7 starts to mix with the liquid plug A6 at its surface. Here, even after the liquid plug B7 comes in contact with the liquid plug A6, the pressurized gas is continuously made to be in contact with the mixed liquid 12 in the mixing chamber 1 direction. This causes the mixed liquid 12 including the liquid plug A6 and liquid plug B7 to move in the bold line direction in the mixing chamber 1.

Furthermore, as illustrated in FIG. 11C, by making the pressurized gas be in contact with the mixed liquid 12 in the direction towards the mixing chamber 1, a circulation is induced in the mixed liquid 12 with the moving of the mixed liquid 12, thereby accelerating the mixing. At the end, the mixed liquid 12 moves to a position as illustrated in FIG. 11D, and the pressurized gas made to be in contact with the mixed liquid 12 flows into the gas exhausting channel section 3. It is preferable to continuously make the pressurized gas be in contact with the mixed liquid 12 even in the state illustrated in FIG. 11D, to maintain the eddy and circulation generated in the mixed liquid 12 for further acceleration of the mixing.

The mixing of the liquid plug A6 and liquid plug B7 as described above is particularly advantageous in a case where the volume of the liquid plug B7 is equal to or greater than that of the liquid plug A6, and makes it possible to efficiently mix liquids that largely differ in volume ratio.

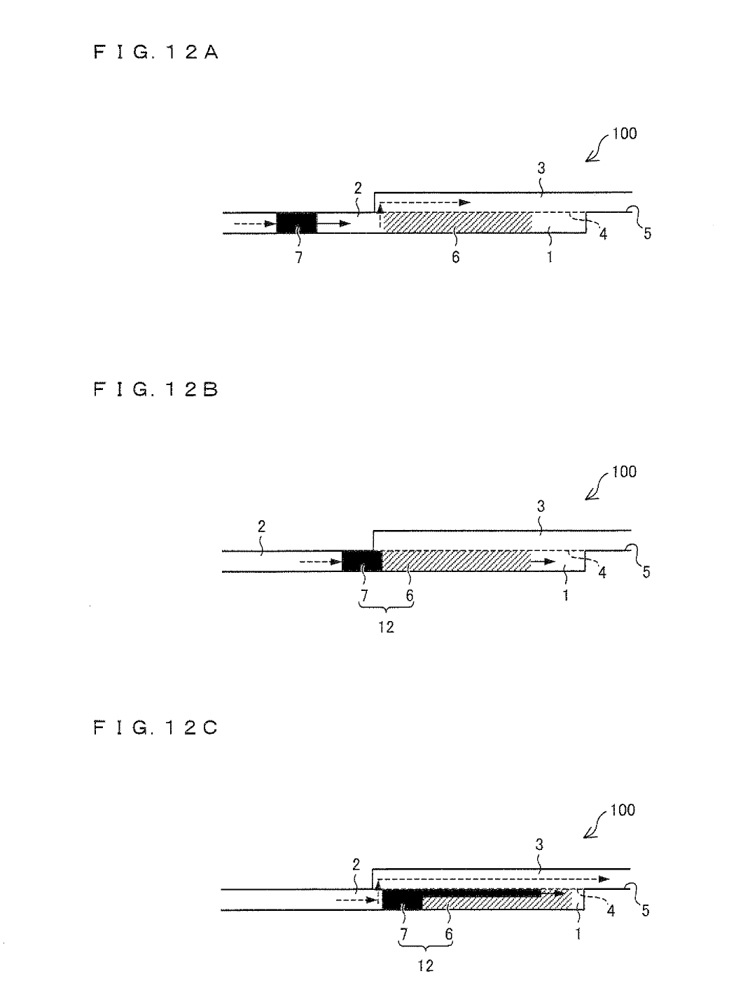

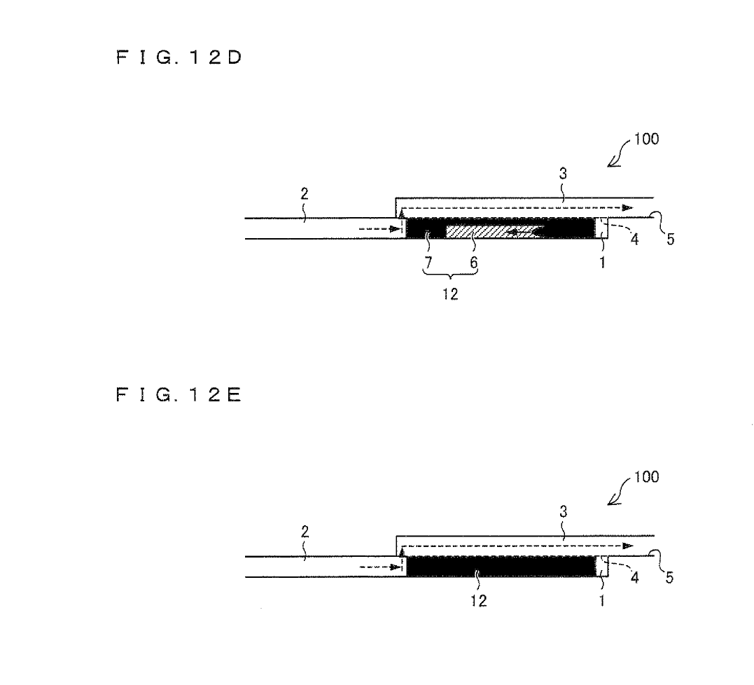

Next described is the mixing of the liquid plug A6 and liquid plug B7 in a case where the volume of the liquid plug B 7 is smaller than the volume of the liquid plug A6, with reference to FIGS. 12A, 12B, 12C, 12D and 12E. FIGS. 12A to 12E are diagrams schematically illustrating mixing of liquid by the micromixer 100. As illustrated in FIG. 12A, the liquid plug B7 flows in the fluid channel section 2 in the direction towards the mixing chamber 1. At this time, the liquid plug B 7 is accelerated by making pressurized gas (first gas) come in contact with the liquid plug B7 that is flowing in the fluid channel section 2 in the mixing chamber 1 direction. The gas is preferably pressurized in a range of not less than 1 kPa but not more than 1 MPa.

The liquid plug A6 stands still in the mixing chamber 1. Gas is present between the liquid plug A6 and the liquid plug B7 in the fluid channel section 2, however this gas flows into the gas exhausting channel section 3 as the liquid plug B7 progresses in the liquid plug A6 direction, as illustrated by the dotted arrow.

Thereafter, as illustrated in FIG. 12B, once the liquid plug B7 comes in contact with the liquid plug A6, mixing of the liquid plug B7 and liquid plug A6 starts on the contacting interface. Even after the liquid plug B7 is made into contact with the liquid plug A6, the gas is continuously made to be in contact with the mixed, liquid 12 in the mixing chamber direction. This causes the mixed liquid 12 including the liquid plug A6 and liquid plug B7 to move in the mixing chamber 1 in the bold arrow direction.

Furthermore, as shown in FIG. 12C and 12D, the gas is made to be in contact with the mixed liquid 12 in the direction towards the mixing chamber 1, and flows into the gas exhausting channel section 3 along the interface of the mixed liquid 12. This induces a circulation in the mixed liquid 12, thereby accelerating the mixing. Finally, as illustrated in FIG. 12E, the gas is continuously made to be in contact until the mixed liquid 12 is completely mixed together. This accelerates mixing of the mixed liquid 12 in an even manner.

As described above, when the volume of the liquid plug B7 that comes into contact in the mixing is smaller than the volume of the liquid plug A6, even if the eddy generated by the contact of the liquid plug B7 to the liquid plug A6 is small, it is possible to continuously generate a circulation in the mixed liquid 12 by continuously causing the gas to be in contact with the mixed liquid 12 including the liquid plug A6 and liquid plug B7. This efficiently mixes the liquid evenly. Thus, the present invention is particularly suitably used for cases such as titrimetric analysis, in which a liquid having a small volume is consecutively introduced in a liquid having a large volume, and thereafter the mixed liquid is mixed.

Particularly, the micromixer 100 has a tubular shaped mixing chamber 1, and the liquid plug B7 or gas comes in contact with the liquid plug A6 from a shorter end of the mixing chamber. This makes a contacting area ratio of the liquid plug B7 or gas with respect to the liquid plug A6 to the most greatest ratio, thereby attaining efficient mixing.

Moreover, a total volume of the liquid plug A6 and liquid plug B7 may be made to be in the range of 1 pL to 1 μL, and a volume ratio of the liquid plug A6 and the liquid plug B7 may be made to be at least 2. With the micromixer 100, in a case where the mixing chamber 1 and fluid channel section 2 have an identical tubular diameter, a longitudinal length of the liquid plug A6 and liquid plug B7 introduced therein will be the volume ratio of these liquids.

The pressure to be applied to the gas that is made to be in contact with the liquid plug B7 and mixed liquid 12 may be adjusted within the foregoing range as appropriate. Further, acceleration of the liquid plug B7 to a desired speed with respect to the volume ratio of the liquid plug A6 and liquid plug B7 that are mixed together is attainable by a simple mechanic arrangement.

By using the micromixer 100 in accordance with the present invention, it is possible to efficiently stir and mix liquid set to a minute amount within a microspace, regardless of its volume ratio or liquid type. Moreover, the micromixer 100 in accordance with the present invention requires no complex machinery. With the conventional mixing devices, mixing is carried out by molecular diffusion. Therefore, the mixing takes a long time, and the mixing channel is necessarily long in length. In comparison, the micromixer 100 in accordance with the present invention accelerates the stirring and mixing by an eddy and circulation that generates due to the liquid plug B7 or gas coming in contact with the liquid plug A6. This shortens the reacting time, and no long reaction channel is necessary.

Furthermore, different from the conventional mixing device that simultaneously introduces two liquids to be mixed together into the mixing channel, the micromixer 100 in accordance with the present invention does not require an accurate control of flow rate and flow amount. Moreover, with the conventional device that mixes droplets by electrowetting, volumes of the droplets are set to an electrode size. This makes it difficult to mix droplets that have a large volume ratio, and the droplets were limited to ones that include electrolytes. The micromixer in accordance with the present invention does not limit the volume ratio or liquid type, and therefore may be applied to analysis that uses a nonpolar organic solvent.

The present invention includes the foregoing micromixer and micromixing method (fluid mixing method). The micromixing method in accordance with the present invention includes not just the liquid stirring and mixing method explained in the present embodiment that uses a micromixer, but also includes a liquid stirring and mixing method that uses a mixer having a similar arrangement.

The following description explains one example of mixing the liquid plug A6 and liquid plug B7 with use of the micromixer 100 in accordance with the present invention. However, the present invention is not limited to this example.

### Example 1

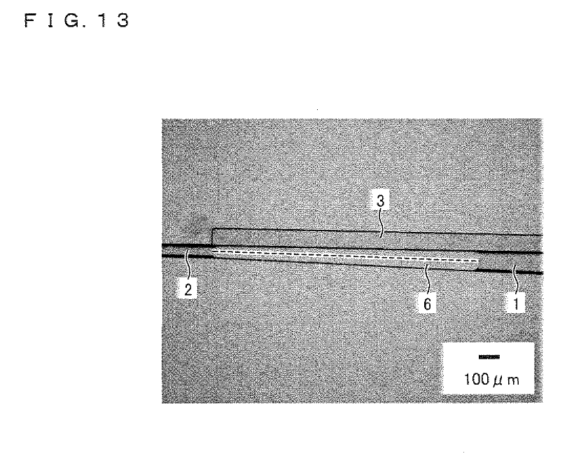

The liquid plug A6 and liquid plug B7 were mixed together with use of a micromixer illustrated in FIG. 13. The micromixer illustrated in FIG. 13 is configured identically to the micromixer 100 illustrated in FIG. 1.

A mixing chamber 1 was formed on a glass substrate by wet etching, so as to have a width at a connecting section of the fluid channel section 2 and the mixing chamber 1 of 70 μm and then gradually broadening its width in a longitudinal direction of the mixing chamber 1 so that the width is broadened until 300 μm. The mixing chamber 1 had a depth of 30 μm, and a length of 8 mm.

The fluid channel section 2 had a width of 70 μm, a depth of 30 μm, and a length of 20 mm, and was formed so as to connect with the mixing chamber 1. As shown in FIG. 13, a gas exhausting channel section 3 was formed on a surface of the mixing chamber 1 and fluid channel section 2 that was (i) parallel to an inflowing direction of the liquid plug B7 and (ii) perpendicular to a surface at which the mixing chamber 1 and fluid channel section 2 were connected. The gas exhausting channel section 3 had a width of 100 μm and a depth of 10 μm.

Furthermore, two volume setting sections 200 which each set a volume of a liquid as like in FIG. 8 were formed and connected to the fluid channel section 2. With each of the two volume setting sections 200, the volume setting channel section 9 had a width of 70 μm and a depth of 30 μm. The two volume setting channel sections 9 had different lengths, so that the liquid plug A6 and liquid plug B7 were set to have different volumes. The valve channel section 10 had a width of 50 μm and a depth of 10 μm. The cutting-off channel section 11 had a width of 90 μm and a depth of 30 μm.

The micromixer formed as such was joined to a different glass substrate having a through-hole for introducing liquid and gas. This completed the configuration of the micromixer. All inner sides of the channels and mixing chambers inside the micromixer were modified to be hydrophobic, with amorphous fluoropolymer. After the different glass substrate was identically modified to be hydrophobic, an angle of contact with respect to water was measured. A measuring result was 117 degrees, thus demonstrating good hydrophobicity.

Pure water was introduced into one of the two volume setting sections 200, and fluorescent dye was introduced into the other one of the two volume setting sections 2. A pressure of gas to be applied in the volume setting section 200 was successively changed by a pressure controller so that a pure water liquid plug A6 and a liquid plug B7 including the fluorescent dye, each having a different volume, were prepared by the foregoing method (volume ratio of approximately 10:1). Next, the liquid plug A6 having the larger volume was introduced into the mixing chamber 1 via the fluid channel section 2. The liquid plug A6 occupied a length of approximately 1.5 mm inside the mixing chamber 1 (FIG. 13).

The liquid plug B7 having a small volume that includes fluorescent dye (equivalent to approximately 0.5 nl) was introduced into the fluid channel section 2. Gas that was pressurized by a pressure controller was made to be in contact with the liquid plug B7, so as to accelerate the liquid plug B7, and cause the liquid plug B7 in the mixing chamber 1 to be in contact with the gas. Thereafter, the gas was continuously made to be in contact with a mixed liquid of the liquid plug A 6 and liquid plug B7, while a change in elapse of time of fluorescent distribution was observed in the mixed liquid in the mixing chamber 1.

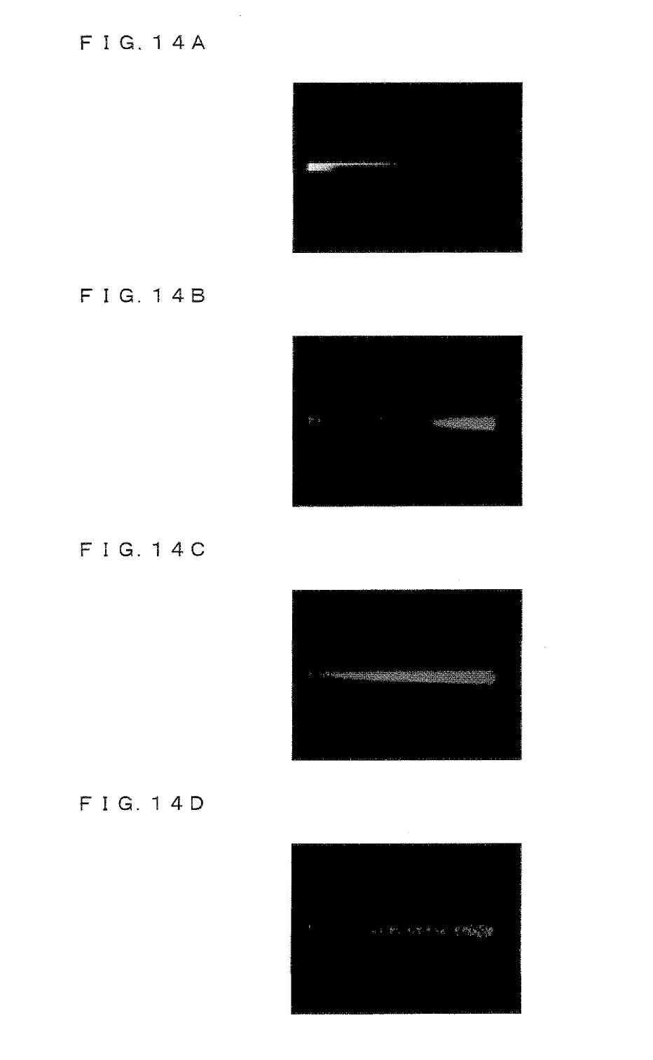

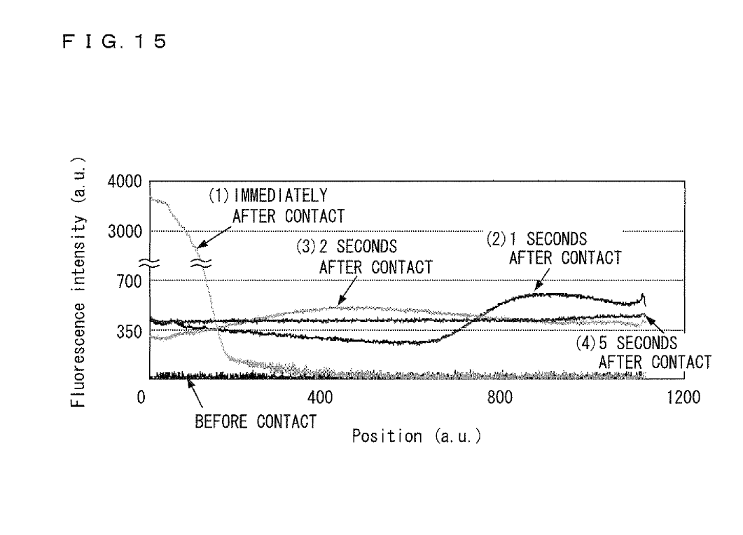

An observation result is illustrated in FIGS. 14A, 14B, 14C, 14D, and 15. FIGS. 14A to 14D are fluorescence images that show the liquid plug A6 and liquid plug B7 immediately after contact to five seconds after contact. FIG. 14A illustrates a fluorescence image immediately after the contact, FIG. 14B illustrates a fluorescence image 1 second after the contact, FIG. 14C illustrates a fluorescence image 2 seconds after the contact, and FIG. 14D illustrates a fluorescence image 5 seconds after the contact. FIG. 15 is a graph showing a result of measuring fluorescence distribution along a longitudinal direction of the liquid plug A6 (horizontal direction in FIGS. 14A to 14D).

As illustrated in FIGS. 14A to 14D, mixing of the liquid plug A6 and liquid plug B7 caused by the eddy and circulation generated by the contact was observed in the mixed liquid. It was observed that 5 seconds after the liquid plug A6 came into contact with the liquid plug B7, the liquid plug A6 and liquid plug B7 were mixed evenly (FIG. 14D and FIG. 15). For reference, a theoretical time required to evenly mix the two liquid plugs in a case where the liquid plug A6 and liquid plug B7 were mixed just by molecular diffusion with use of an identical reaction system as the micromixer in accordance with the present invention, is approximately 3,000 seconds. Therefore, it was demonstrated that use of the micromixer in accordance with the present invention attains a great effect in quick mixing of liquids.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is suitably used in analysis chips used in chemical and biological fields, such as in genetic screening and tritration.

### Reference Signs List

1 mixing chamber
2 fluid channel section
3 gas exhausting channel section
3a to 3e gas exhausting channel section
4 pressure barrier
4a to 4e pressure barrier
5 opening
6 liquid plug A (first liquid)
7 liquid plug B (second liquid)
8 liquid component
9 volume setting channel section
10 valve channel section
11 cutting-off channel section
12 mixed liquid
100 to 104 micromixer (fluid mixing device
200 volume setting section (volume setting section)

What is claimed is:

1. A fluid mixing device comprising:
a mixing chamber in which a first liquid is introduced; and
a fluid channel section connected to the mixing chamber, in which fluid is introduced,
the fluid flowed in the fluid channel section being accelerated in a direction towards the mixing chamber, so that the fluid flows into the mixing chamber and comes in contact with the first liquid.

2. The fluid mixing device according to claim 1, further comprising:
a gas exhausting channel section in which gas is flowed, provided on a surface parallel to an inflowing direction of the fluid and connected to the mixing chamber.

3. The fluid mixing device according to claim 2, further comprising:
a first pressure section for applying pressure to the mixing chamber from a gas exhausting channel section side on an interface of the mixing chamber and the gas exhausting channel section, to form a pressure barrier that prevents a liquid component in the mixing chamber from flowing into the gas exhausting channel section.

4. The fluid mixing device according to claim 2, wherein:
a first distance of the gas exhausting channel section is of a same length or shorter than a second distance of the mixing chamber, the first distance and second distance being in a direction (i) perpendicular to an inflowing direction of the fluid and (ii) parallel to an interface of the mixing chamber and the gas exhausting channel section.

5. The fluid mixing device according to claim 4, wherein:
the second distance has a ratio with respect to the first distance of not less than 1 but not more than 10.

6. The fluid mixing device according to claim 2, wherein:
at least one of the mixing chamber, the fluid channel section, and the gas exhausting channel section has a hydrophobic inner section.

7. The fluid mixing device according to claim 6, wherein:
at least one of the mixing chamber, the fluid channel section, and the gas exhausting channel section has an angle of contact with respect to water in its inner section of not less than 90 degrees but not more than 180 degrees.

8. The fluid mixing device according to claim 1, wherein:
the mixing chamber has a capacity greater than (a) a volume of the first liquid in a case where the fluid is a gas or (b) a total of volumes of the first liquid and the second liquid in a case where the fluid is a second liquid.

9. The fluid mixing device according to claim 8, wherein:
(a) the volume of the first liquid in the case where the fluid is a gas and (b) the total of volumes of the first liquid and the second liquid in the case where the fluid is a second liquid are not less than 1 pL but not more than 1 μL.

10. The fluid mixing device according to claim 1, wherein:
the fluid is a second liquid,
the fluid mixing device further comprising:
at least one volume setting section connected to the fluid channel section, for introducing the first liquid or second liquid that is set in volume, into the fluid channel section.

11. The fluid mixing device according to claim 10, wherein:
the volume setting section comprises:
a cutting-off channel section for flowing the first liquid or second liquid therein;
a volume setting channel section connected to the cutting-off channel section so as to intersect at right angles with a flowing direction of the first liquid or second liquid flowing in the cutting-off channel section, the volume setting channel section having an identical capacity to the first liquid or second liquid of the set volume;
a valve channel section connected between the volume setting channel section and the fluid channel section; and
a second pressure section for (i) applying a first pressure to an interface of the volume setting channel section and the valve channel section from the valve channel section side so that the volume setting channel section is filled with the first liquid or second liquid flowing in the cutting-off channel section, the first pressure preventing the first liquid or second liquid from flowing into the valve channel section from the volume setting channel section, and thereafter (ii) applying a second pressure higher than the first pressure to the first liquid or second liquid in the volume setting channel section from the cutting-off channel section side.

12. The fluid mixing device according to claim 10, wherein:
the fluid mixing device includes a plurality of volume setting sections which respectively have volume setting channel sections of different capacities.

13. The fluid mixing device according to claim 1, further comprising:
a pressure applying section for applying a third pressure to a fluid introduced into the fluid channel section, to accelerate the fluid in the direction towards the mixing chamber.

14. The fluid mixing device according to claim 13, wherein:
the third pressure is not less than 1 kPa but not more than 1 MPa.

15. A fluid mixing method comprising:
(A) causing a first liquid introduced in a mixing chamber to come in contact with a fluid accelerated in a direction towards the mixing chamber.

16. The fluid mixing method according to claim 15, further comprising:
accelerating the fluid before the step (A), by applying a fourth pressure to the fluid in the direction towards the mixing chamber,
in the step (A), the fluid thus accelerated being caused, to come in contact with the first liquid.

17. The fluid mixing method according to claim 16, wherein:
the fourth pressure is not less than 1 kPa but not more than 1 MPa.

18. The fluid mixing method according to claim 15, wherein:
the mixing chamber is tubular shaped, and
in the step (A), the fluid is caused to come in contact with the first liquid from a shorter side of the mixing chamber.

19. The fluid mixing method according to claim 15, wherein:
the fluid is a second liquid,
the fluid mixing method further comprising:
accelerating the second liquid before the step (A), by causing a first gas to come in contact with the second liquid in the direction toward the mixing chamber,
in the step (A), the second liquid thus accelerated being caused to come in contact with the first liquid.

20. The fluid mixing method according to claim 19, wherein:
pressure is applied to the first gas in a range of not less than 1 kPa to not more than 1 MPa.

21. The fluid mixing method according to claim 15, wherein:
the fluid is a second liquid, and
the step (A) comprises:
causing, after the first liquid comes in contact with the second liquid, a second gas to come in contact with a mixed liquid of the first liquid and second liquid so as to flow the second gas along an interface of the mixed liquid.

22. The fluid mixing method according to claim 21, wherein:
in the step (A), the second gas is caused to be in contact with the mixed liquid so that the mixed liquid moves inside the mixing chamber.

23. The fluid mixing method according to claim 15, wherein:
the fluid is a second liquid, and
the first liquid has a volume different from that of the second liquid.

24. The fluid mixing method according to claim 15, wherein:
a total of volumes of the first liquid and the second liquid is not less than 1 pL but not more than 1 μL.

25. The fluid mixing method according to claim 15, wherein:
the fluid is a third gas, and
the step (A) comprises:
causing the third gas to come in contact with the first liquid so as to flow the third gas along an interface of the first liquid.

26. The fluid mixing method according to claim 25, wherein:
the first liquid has a volume of not less than 1 pL but not more than 1 μL.
